(19) United States
(12) Patent Application Publication
(10) Pub. No.: US 2025/0292095 A1
(43) Pub. Date: Sep. 18, 2025

(54) FEED ENRICHMENT USING SELF-SUPERVISED MULTIMODAL LARGE LANGUAGE MODELS

(71) Applicant: Shopsense, Inc., Redwood City, CA (US)

(72) Inventors: Dharmil Chandarana, Redwood City, CA (US); Tabrez Mohammed, Redwood City, CA (US); Sam Gottlieb, Redwood City, CA (US); Glenn Fishback, Redwood City, CA (US)

(21) Appl. No.: 19/076,792

(22) Filed: Mar. 11, 2025

Related U.S. Application Data
(60) Provisional application No. 63/564,250, filed on Mar. 12, 2024.

(51) Int. Cl. G06N 3/0895

(52) U.S. Cl. CPC G06N 3/0895

(57) ABSTRACT

A system and method for enhancing data feed using a machine learning (ML) model are disclosed. In some embodiments, the method includes receiving multimodal data associated with a plurality of data items and providing, from the received multimodal data, a set of multimodal data samples to the ML model, each multimodal data sample associated with two or more modalities. The method also includes training the ML model using the set of multimodal data samples by optimizing a similarity value computed for each multimodal data sample based on whether the multimodal data sample is associated with a same data item or from different data items. The method further includes receiving new data associated with a new data item, the new data including one or more data components to be enriched, and automatically populating the one or more data components using the trained ML model.

### CROSS REFERENCE TO RELATED APPLICATION

This application claims the benefit of and priority to U.S. Provisional Patent Application No. 63/564,250, filed Mar. 12, 2024, the entire content of which is incorporated by reference herein.

### TECHNICAL FIELD

This disclosure relates to machine learning, in particular, to continuously and automatically enhancing data feeds using self-supervised multimodal large language models (MLLMs).

### BACKGROUND

A large volume of diverse data from heterogeneous sources is crucial for analysis, optimization, and other applications. The data may include product data, network data, internet of things (IoT) data, biomedical data, etc., that span various technical domains. However, this data is often semi-structured and incomplete. There is no universal standard regulating the attributes that should be captured, leading to inconsistencies in data collection. As a result, key attributes may be missing or inconsistently recorded, complicating efforts to analyze, classify, and monitor information effectively. The issue becomes even more significant when integrating the data from independent sources, making it difficult to maintain up-to-date, relevant, accurate, and comprehensive insights for various analytical and operational purposes.

Hence, a system that populates missing values associated with a set of attributes and enriches the data feed in a continuous and automatic manner is desirable.

### SUMMARY

To address the shortcomings mentioned above, a system and method for enhancing data feed using a machine learning (ML) model are disclosed. In some embodiments, the method includes receiving multimodal data associated with a plurality of data items and providing, from the received multimodal data, a set of multimodal data samples to the ML model, each multimodal data sample associated with two or more modalities. The method also includes training the ML model using the set of multimodal data samples by optimizing a similarity value computed for each multimodal data sample based on whether the multimodal data sample is associated with a same data item or from different data items. The method further includes receiving new data associated with a new data item, the new data including one or more data components to be enriched, and automatically populating the one or more data components using the trained ML model.

The above and other preferred features, including various novel details of implementation and combination of elements, will now be more particularly described with reference to the accompanying drawings and pointed out in the claims. It will be understood that the particular methods and apparatuses are shown by way of illustration only and not as limitations. As will be understood by those skilled in the art, the principles, and features explained herein may be employed in various and numerous embodiments.

### BRIEF DESCRIPTION OF THE DRAWINGS

The disclosed embodiments have advantages and features that will be more readily apparent from the detailed description, the appended claims, and the accompanying figures (or drawings). A brief introduction of the figures is below.

FIG. 1A illustrates an exemplary block diagram of a data-feed enrichment system, according to some embodiments.

FIG. 1B illustrates an exemplary block diagram of data feed enrichment, according to some embodiments.

FIG. 2 illustrates an exemplary diagram of model training in the present system, according to some embodiments.

FIG. 3 illustrates an exemplary diagram of item-level processing, according to some embodiments.

FIG. 4 illustrates an exemplary flowchart of enhancing data feed using a machine learning (ML) model, according to some embodiments.

FIG. 5 illustrates a block diagram of an example computer system that may be used in implementing the technology described herein, according to some embodiments.

### DETAILED DESCRIPTION

The FIGURES (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### System Overview

Language models have emerged as a promising artificial intelligence (AI) trend. Some existing language models have been trained on large, diverse datasets to understand and generate language in a broad context. The present disclosure proposes a system that leverages recent advancements in large language models (LLMs), especially a multi-modal LLM (MLLM) to automatically and continuously populate missing attribute values.

Advantageously, the proposed system can enhance data feed (e.g., network traffic data, product feed) without collecting any additional data. For example, the proposed system can intelligently infer and supplement missing or incomplete network attributes based on available contextual information to enhance network traffic data feeds without requiring additional data collection from network service providers, enterprise systems, or other sources. The proposed system may employ one or more machine learning (ML) or AI models (e.g., multi-modal large language model) to analyze available data (e.g., packet metadata, flow characteristics, or historical traffic patterns), and determine and add missing information (e.g., application type, service category, potential security risk level, etc.). For example, if a network log lacks protocol classification, the present system could infer the classification based on packet size, timing, known communication patterns, etc. Alternatively, in a raw product database, a product description may be missing or incomplete, leading to incorrect categorization and inefficient indexing. This can hinder accurate product discovery and retrieval when users query the database. The proposed system can address this issue by enriching the database with detailed and contextually relevant product descriptions and/or inferring the most appropriate product category, even when such data is initially absent. The proposed system can continuously update and refine product metadata, ensuring they align with the latest trends or user search patterns. Without the need for additional external data or manual input, the proposed system improves the quality of the product database, ensuring that the most accurate and relevant results are returned in response to user queries.

Additionally, in some embodiments, the proposed system can continuously enrich the data feed by employing (i) supervised learning on new incoming data feeds and/or (ii) self-supervised learning on previously generated labels and predictions. Continuing with the above example, when new data (e.g., fresh network logs, traffic pattern data, etc.) arrives, the proposed system can train on labeled data to refine the ability to classify and predict network attributes. For example, if the labeled data contains information on both benign and malicious network behavior, the proposed system can improve its ability to accurately assign missing security classifications, such as differentiating legitimate traffic from potential cyber threats. The proposed system also performs self-supervised learning such that the system can iteratively refine its understanding of data patterns (e.g., network behavior) by validating and learning from the system's past predictions. For example, if the present system initially predicts that an unidentified internet protocol (IP) address belongs to a content delivery network) based on certain characteristics, the proposed system can reinforce or correct that classification over time based on future network traffic from similar IPs.

While the present disclosure is illustrated in the context of example data feed (e.g., network traffic data, product feed) for simplicity and clarity, it should be noted that the system and approach described herein are applicable for enhancing and optimizing other types of data. The description herein is intended as illustrative and in no way limiting.

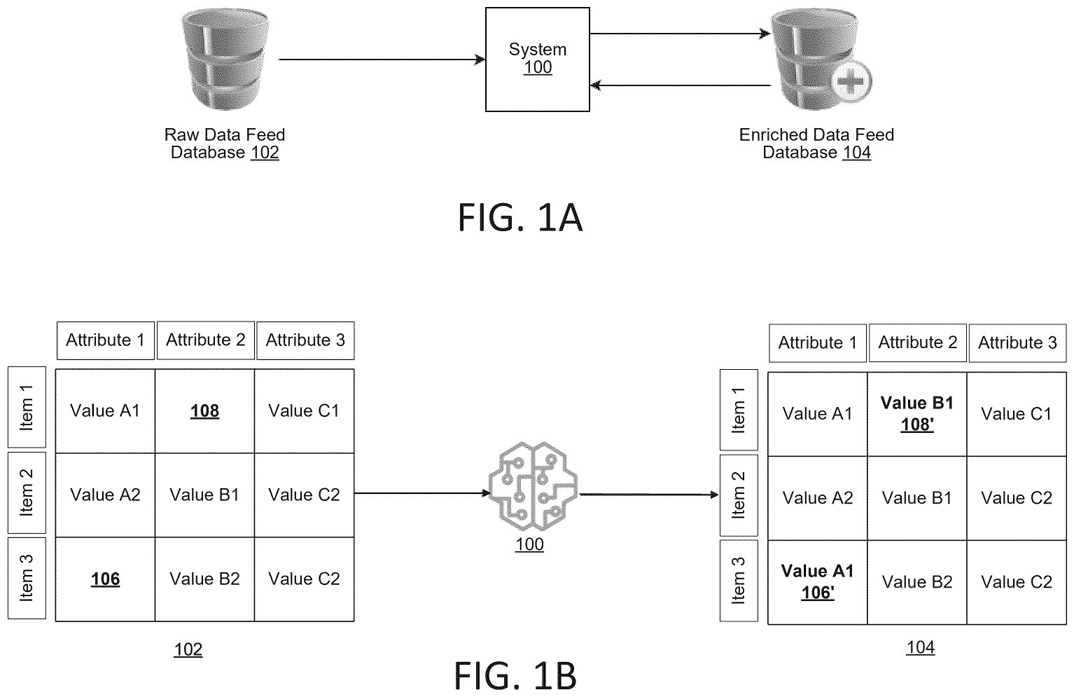

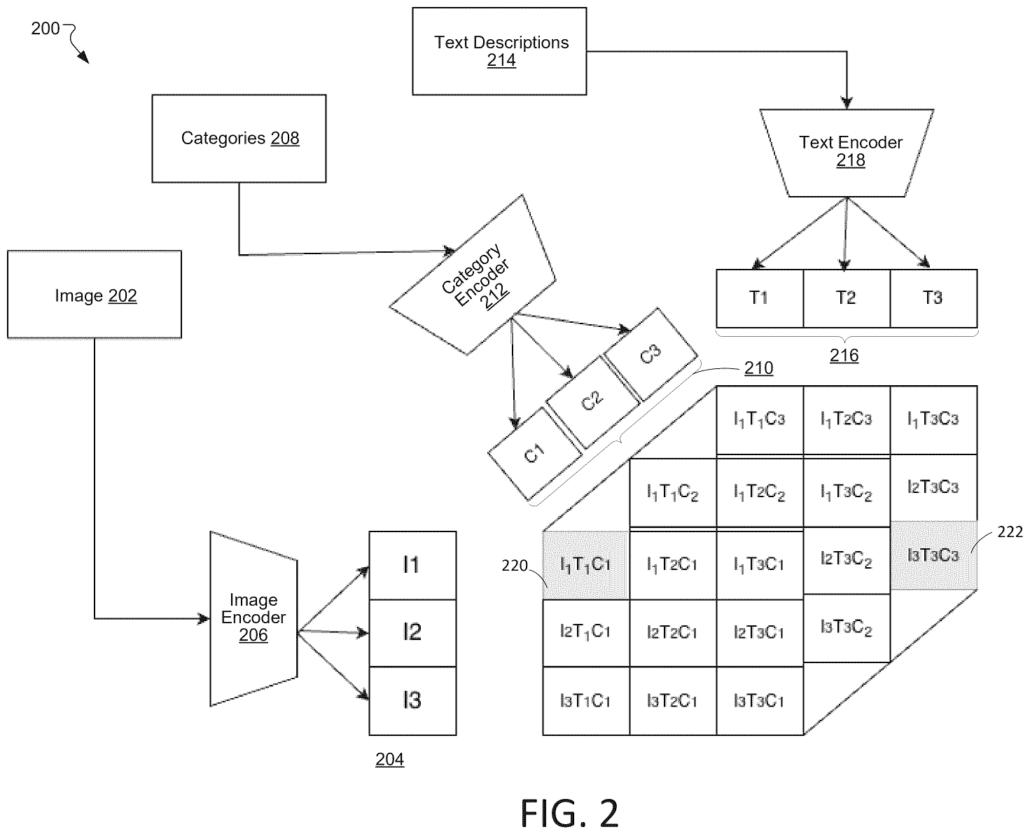

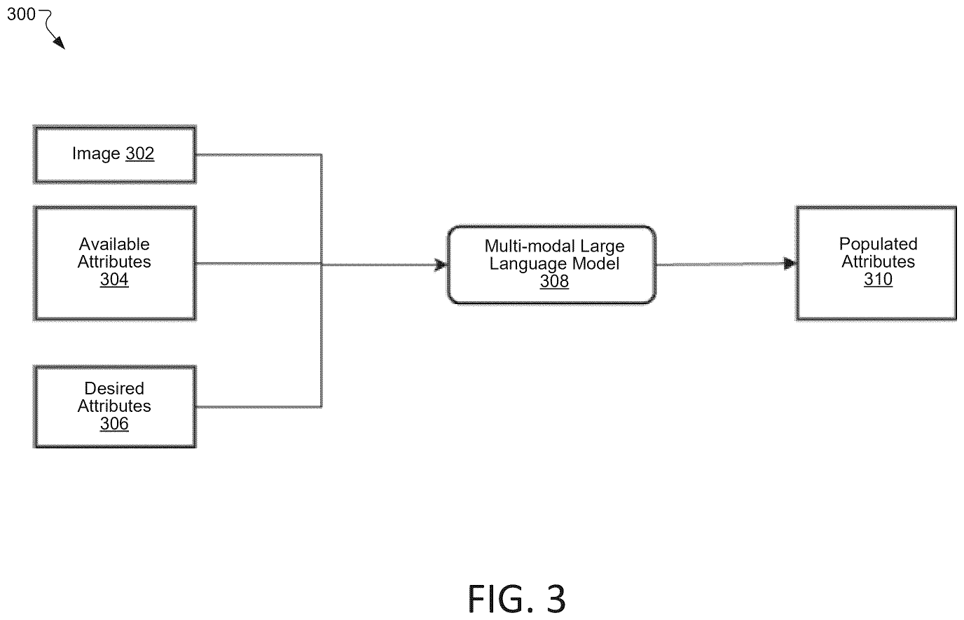

FIG. 1A illustrates an exemplary block diagram of a data-feed enrichment system 100, according to some embodiments. A raw data feed database 102 may be configured to store data feeds from various sources. The proposed system 100 aims to use an artificial intelligence (AI)-based approach to improve and optimize raw data feed database 102 to achieve an enriched data feed database 104, as detailed below in FIGS. 2 and 3.

For example, raw database 102 may store network logs (e.g., IP addresses, protocols, packet sizes, timestamps, etc.) collected from various sources (e.g., firewalls, intrusion detection systems (IDS), routers, cloud services, etc.). Raw database 102 records these logs in different formats such as JavaScript object notation (JSON), packet capture (PCAP), comma-separated values (CSV), syslog formats, etc., and the raw traffic feed data within these logs is often incomplete or inconsistent, leading to ineffective security analysis and network optimization. The proposed system 100 is configured to automatically enhance and optimize raw network traffic database 102 (e.g., using ML-based classification, automated anomaly detection, metadata enrichment, etc.), resulting in an enriched traffic data database 104.

Suppose a firewall logs incoming and outgoing traffic but fails to provide data about the type of applications being accessed, such as whether a connection is related to a streaming service, a cloud application, or a suspicious unauthorized access attempt. The proposed system 100 can analyze historical traffic patterns and infer missing data based on known behaviors of similar IP addresses and network protocols. The proposed system can apply ML models trained on labeled datasets to classify whether a given network session belongs to a benign service (e.g., video streaming) or a potential security threat (e.g., data exfiltration attempt). Additionally, the present system can enrich the raw traffic logs by adding attributes such as estimated application type, risk score, anomaly detection results, etc.

By leveraging these techniques, enriched traffic data database 104 becomes a more reliable and actionable resource for network and security administration. It enables better detection of cyber threats, improved network performance optimization, and more effective enforcement of security policies.

In another example, raw database 102 stores product feed data, where the product feed is a list of files with products and product information such as product name, product identifier, product image, product price, product description, product dimensions, etc. Retailers use these feeds to add their products to online shopping platforms and markets, and customers make their shopping decisions based on the retail product list. Typically, raw product feed database 102 may store product feeds created in various file formats, including CSV, TXT, and extensible markup language (XML) files. However, as discussed above, the feed information in existing databases often is not complete and accurate enough to support the best performance. Proposed system 100 is implemented to achieve an enhanced database 104 with improved performance.

FIG. 1B illustrates an exemplary block diagram of data feed enrichment. In some embodiments, a data feed database (e.g., 102, 104) stores various types of data, for example, logs about network activities collected from heterogeneous sources or detailed information about retail products available for sale on e-commerce websites. The feed data is typically maintained in a structured tabular format and hosted on a cloud-based database service for scalability and accessibility.

The feed database is dynamic. For example, the network traffic database is continuously updated as new network sessions, packet transmissions, and security events are logged, while the product database modifies as new products are added or when additional information becomes available for existing products. The feed database is designed to handle millions of items (e.g., network events, products), each item containing multiple (e.g., dozens, hundreds) attributes. These attributes belong to different data modalities such as textual, numerical, binary, and multimedia content. For example, the data modalities associated with network traffic event attributes can be textual (e.g., domain names), numerical (e.g., bandwidth usage), and binary (e.g., encrypted vs. unencrypted traffic), whereas product data modalities may include textual (e.g., product descriptions), numerical (e.g., prices, dimensions), binary (e.g., availability status), and multimedia content (e.g., images and videos). The data (e.g., attributes) associated with multiple modalities is also referred to as multimodal data.

In practice, however, the raw data available is often incomplete. For example, some network attributes may be missing due to packet loss, logging limitations, or misconfigured monitoring systems, while some of the product attribute values may be absent for certain products. This data gap can reduce the effectiveness of cybersecurity measures, anomaly detection, and network performance optimization, or negatively impact search, recommendations, and customer decision-making on e-commerce platforms. The proposed system 100 is intended to fill the gap by identifying and completing missing attribute data. As shown in FIG. 1B, certain values in raw database 102 are missing. For example, value 106 associated with attribute 1 of item 3 (e.g., the protocol type in a specific session) and value 108 associated with attribute 2 of item 1 (e.g., the application category of a network connection) are lost. Using proposed system 100 (e.g., ML-based classification), these values may be inferred, retrieved, or reconstructed, leading to an enriched product feed database 104, where the missing values are restored as 106′ and 108′, respectively.

### Technical Benefits

An enriched feed database (e.g., 104) optimizes computer resource usage, improves processing efficiency, and enhances the performance of subsequent AI models (e.g. when enriched data is used as training data).

The present system can reduce redundant computations (e.g., repeated lookups or inferences at runtime) through pre-filling missing attributes in a data feed. An enriched dataset enables more efficient data indexing and retrieval result in lower CPU cycles required for querying large datasets. Pre-processed attributes also reduce real-time processing loads, shifting computational effort to batch processing. For example, in network security, if packet logs are pre-enriched with protocol classifications, an IDS may not need to recompute these values for every new request and thus save CPU cycles. By reducing the need for on-the-fly computations, real-time analytics is enabled. For example, a network intrusion prevention system using an enriched dataset can immediately flag suspicious traffic instead of analyzing incomplete logs in real time. A search engine for an online store that uses enriched product data can return accurate search results faster, improving user experience.

The structured and enriched data (e.g., categorical encoding of missing values) requires less storage space than multiple incomplete records with missing or redundant values. By normalizing and filling in attributes systematically, irrelevant traffic attributes and data duplication can be avoided, making data storage more memory-efficient.

Using the enriched data feed described herein, network bandwidth usage is reduced. For example, fewer repeated queries to databases are required for missing attributes, reducing overall data transmission costs. Pre-filling missing information also eliminates the need for additional data requests during inference or model execution. The enriched feed further enables faster synchronization across distributed systems. For example, a real-time AI-based chatbot fetching product details from a remote application programming interface (API) may require fewer network calls if attributes are already completed in the enriched database. Security monitoring tools that rely on enriched log data need fewer back-and-forth requests to threat intelligence databases, improving network efficiency.

The present system can use the enhanced data to provide more complete and diverse training data to AI Model(s), leading to improved AI model generalization. An AI model can be a predictive model for detecting network anomalies, estimating a popularity trend, etc. The enriched data can reduce model bias caused by incomplete or imbalanced datasets, and further enable models to converge faster during training. For example, a computer vision model trained on an enriched product feed (e.g., where missing attributes are filled using multi-modal learning) can perform better in item classification than a model trained on incomplete data.

A practical example is described herein to show how the present data-feed enrichment system (e.g., 100) can lead to significant technical improvements, including less CPU usage (e.g., by reducing redundant computations), lower memory footprint (e.g., by structuring and normalizing missing attributes), reduced network usage (e.g., by minimizing unnecessary data requests), better AI model accuracy & faster convergence (e.g., due to high-quality training data), and/or improved real-time system performance (e.g., through optimized querying and retrieval).

Suppose a network intrusion detection and prevention system (IDPS) monitors incoming traffic (e.g., network packets) to detect and mitigate malicious activity (e.g., identifying potential threats such as DDOS attacks, malware communication, or unauthorized access attempts). As discussed above, the raw packet data (e.g., IP, port number, protocol, payload information) received by the IDPS may lack key attributes (e.g., detailed threat classification, reputation scores, etc.). Such incomplete information may lead to false negatives (missed threats), false positives (blocking legitimate traffic), and/or slower response times when the IDPS determines whether a packet is malicious or legitimate.

The present approach can be applied to enhance the received raw data by filling the gap of missing data. For example, in the enhanced database (e.g., 104), threat intelligence information may be added such that the IDPS can determine if an IP is flagged as malicious from external security feeds (e.g., known malware servers). Protocol and application context may be included to allow the IDPS to determine if the traffic behavior matches expected usage (e.g., secure shell traffic (SSH) over port 22). One or more anomaly scores and behavioral insights may be added for the IDPS to detect deviations from normal activity (e.g., a sudden spike in login attempts). Data on geo-location and risk assessment may also be retrieved and/or determined so that the IDPS can identify traffic from high-risk regions or anonymous proxies (e.g., the onion router (TOR) exit nodes).

The IDPS may receive raw data of a network packet, including source IP, destination IP, port, and protocol information. Based on this raw data, the IDPS may determine that this network packet is attempting to connect to an internal database server, and thus allow the connection, potentially exposing the database to a cyber threat. Once the present approach is applied, the packet data is enriched with data such as a geo-location, an anomaly score, etc. As a result, the IDPS may determine the source node of this network packet is a TOR exit node that is often used by attackers, and assign a 90% threat score to this source IP based on past malicious activity. This may trigger an anomaly alert and cause the IDPS and/or associated system(s) to drop this specific network packet, preventing unauthorized access.

Therefore, by ensuring completeness, efficiency, and intelligence in data feeds, an enriched feed database is important for high-performance computing, AI applications, and large-scale data-driven systems.

### Feed Enrichment System

In some embodiments, the present system enhances a data feed database based on automatically and continuously populating additional attribute values by using (i) multi-modal large language model (MLLM) and (ii) agents that interact with the MLLM and transfer data to and from the data feed database. The MLLM is capable of processing and understanding multiple data types (e.g., text, images, numerical values, structured data), and generates relevant updates based on missing attribute values. The agents facilitate the seamless flow of information by querying the MLLM for missing values, retrieving the predictions from the MLLM, and updating the enriched data back into the data feed database.

For example, if a product's description is absent, the MLLM can generate a relevant description based on the product's image and category (e.g., “This is a white cotton T-shirt with a round neck, ideal for casual wear”). The agent(s) interacting with the MLLM can update the product feed database with the newly generated content, improving the product catalog's completeness and usability for search and filtering. Alternatively, if a network packet is identified but lacks the protocol type (e.g., HTTP, FTP), the MLLM described herein can infer the protocol based on packet size, frequency, or patterns associated with known protocols, whereas the agents query the MLLM for the missing values and automatically enrich the network database with the new protocol data. This enhances the overall effectiveness of a network monitoring system.

### Learning Models

Recent advancements in large language models (LLMs), such as generative pre-trained transformers (GPT), have led to remarkable capabilities in understanding and generating human-like language across various tasks (e.g., classification, clustering, sentiment analysis). There is a growing demand for using these models to effectively comprehend and generate text within specific domains such as network monitoring, computer usage, e-commerce, healthcare, and legal domains, etc. In some embodiments, the proposed system may include a specialized MLLM. This MLLM may be derived by fine-tuning a publicly available state-of-the-art (SOTA) MLLM on specific datasets (e.g., network traffic data, product data). The fine-tuning or training process may be configured to enhance the model's ability to enrich or populate data feeds, leveraging techniques such as few-shot learning and/or retrieval augmented generation (RAG) to improve its accuracy in filling in missing attributes.

### Model Training/Fine-Tuning

In some embodiments, the present system follows a contrastive learning approach to train the MLLM. Contrastive learning trains a model to differentiate between similar and dissimilar data pairs. Based on contrastive learning during training/fine-tuning, the present system may use the MLLM to effectively process and integrate information from different data modalities. A modality may be textual, numeric, binary, or multi-media content. In some embodiments, the present system may process a batch of image-text-category triplets, i.e., parallel process a collection of data samples (triplets) together as a group. The model may compute the similarity between the visual, textual, and categorical representations of each triplet, aiming to bring similar text, images, and categories closer together in an embedding space. Based on the computed similarity metric(s), the present system can maximize the similarity between matching triplets and minimize the similarity for non-matching triplets. For example, if an image is associated with the correct text and category, the present system utilizes the MLLM to reinforce their closeness in the embedding space, ensuring that similar data points are grouped. If an image is paired with an incorrect text description or an incorrect category, the MLLM learns to separate them in the embedding space, reducing the chances of misclassification. In this way, the MLLM can effectively align visual, textual, and categorical features effectively, allowing the system to perform retrieval across multiple modalities. By integrating contrastive learning into the fine-tuning process, the present system ensures more accurate data enrichment, classification, and retrieval, ultimately improving performance in multi-modal data processing in a wide range of domains (e.g., e-commerce, cybersecurity, etc.).

FIG. 2 illustrates an exemplary diagram 200 of implementing a model training process in the present system. Suppose a training dataset includes information on data items D₁, D₂, D₃, . . . , D_{N}. A data item is a single unit of data that contains specific attributes or properties, representing an entity in a dataset. For example, data items can be network events, system logs, cybersecurity alerts, products, etc. Each data item Dᵢ may be associated with one or more attributes in specific fields. The present system processes these attributes using different encoders to generate meaningful latent representations for model training.

In the illustrated embodiment, each data item Dᵢ is associated with three dimensions or modalities. First, each data item Dᵢ may have an associated image representation 202, which is transformed into a latent representation Iᵢ 204 using an image encoder 206. For example, an IDS often visualize network traffic as heatmaps, spectrograms, or flow diagrams. A system log analyzer could convert system activity data into time-series visualizations for anomaly detection. Alternatively, the image 202 may include a product image. A latent representation is a compressed, abstract form of input data that captures its most important features. It is typically generated by a neural network model during the encoding process, where high-dimensional raw data (e.g., images, text, or network logs) is transformed into a lower-dimensional space while preserving key information. Latent representations help models identify patterns, similarities, and relationships in complex data without retaining all the original details.

Second, the data item Dᵢ may have categorical attributes 208, which are transformed to a latent representation 210 using a category encoder 212. Categories 208 may be attributes related to network or system properties such as event types (e.g., DDOS attack, SSH connect attempt, firewall alert, etc.), protocols used (e.g., transmission protocol (TCP), user datagram protocol (UDP), etc.), source and destination classifications (e.g., internal IP, external IP, TOR exit node, virtual private network (VPN) traffic, etc.). Product category attributes may include color, material, intended gender, etc.

Finally, each data item Dᵢ may have an associated textual description 214, which is transformed into a latent representation 216 using a text encoder 218. Textual description 214 may include log messages or packet analysis summaries. In an alternative scenario, textual description 214 may be a product description.

While the present model training approach is described herein based on data triplets of three dimensions or modalities, this approach can be applied to other dimensions or modalities. While the triplets including visual, textual, and categorical features are used in the present model training process, triplets with different modalities may be applied. The description herein is intended as illustrative and in no way limiting.

In some embodiments, the present system may implement the model training process in a batch mode (e.g., using a batch size of b) so that information from multiple data items can be clustered together across multiple dimensions. In the illustrated embodiment of FIG. 2, the three dimensions are image, categories, and textual description. The model training in a batch mode may create a 3D matrix of size “b×b×b” with each entry being a triplet and each axis of the matrix representing one of the three dimensions.

In some embodiments, the present system may determine each entry of the matrix by computing the relationship between latent representations of different dimensions using similarity metrics (i.e., performing similarity computation on the triplets of latent representations from the same or different data items). For example, in FIG. 2, one entry in the matrix would comprise a similarity value obtained by a computation on I₁, C₁, and T₁, whereas the similarity value S₂ of an adjacent entry would be obtained by a computation on I₁, C₁, and T₂. In some embodiments, a similarity metric may include a vector dot product or cosine similarity.

The objective of training the MLLM in the present system is to maximize the similarity between matching triplets while minimizing the similarity for non-matching triplets. As indicated in FIG. 2, this means (i) maximizing the values for diagonal entries, which represent computed latent representations from the same data item (e.g., 220 and 222); and (ii) minimizing the values on non-diagonal entries of different data items (e.g., the remaining values in the table). This training process is repeated for all batches of the training data set until a convergence criterion is met, meaning the model has effectively learned to align correct triplets while separating incorrect ones.

### Model Inference

In some embodiments, the present system trains the model using contrastive learning as stated above on training data, where the desired attributes for each data item are available. This trained model is then applied to predict and populate missing values for data items where certain attributes are absent. Specifically, if the triplet (I, C, T) of a data item has a missing component in a diagonal entry of the similarity matrix, the trained MLLM can be used to infer or reconstruct the missing component by maximizing the similarity value in this entry. Since diagonal entries correspond to latent representations derived from the same data item, the MLLM ensures internal consistency when predicting missing attributes.

Conversely, if the missing component I, C, or T pertains to a non-diagonal entry (i.e., where the similarity is computed across different data items), the MLLM is trained to predict the missing part based on minimizing the similarity value in the entry. This mechanism prevents the model from erroneously assigning attributes from unrelated data items, maintaining data integrity. For example, upon receiving the image and description of a fashion item, the MLLM described herein can predict relevant missing attributes such as color, material, and intended gender, ensuring that the enriched dataset remains accurate and reliable.

In some embodiments, the MLLM is further trained to predict category-specific attributes based on the data item's classification. For example, if the MLLM identifies that an item belongs to a category (e.g., dress category), it can predict associated attributes and attribute values (e.g., neckline type, sleeve style, or fabric material). In a network security context, if the MLLM identifies that a data packet belongs to a specific protocol category (e.g., SSH traffic), it can infer relevant attributes such as encryption type, authentication method, or session duration. The present system may also unify taxonomies across different datasets. For example, the MLLM can be applied to recognize and merge seemingly disjoint but lexically similar categories, e.g., “sundresses” and “summer dresses,” to simplify downstream processing, improve search functionality, and enhance filtration for users. Alternatively, the present system can standardize network traffic classifications across different monitoring tools. By leveraging the MLLM, seemingly distinct but functionally similar traffic categories, such as “SSH over TCP” and “SSH tunneling,” can be identified and unified. This enhances anomaly detection, improves log analysis, and optimizes rule-based security filtering.

To improve the efficiency and accuracy of attribute prediction, in some embodiments, the present system may also leverage retrieval-augmented generation (RAG). The present system may automatically generate contextual prompts (e.g., based on product types) and provide categorical labels as context for the MLLM. These contextual information help refine attribute value prediction by leveraging domain-specific knowledge. In some embodiments, the present system may also transform input data into a target format and/or schema, ensuring compatibility across various data pipelines. For example, input data in a comma-separated values (CSV) format may be automatically converted into a structured JavaScript object notation (JSON) format to align with a target database schema.

Referring back to FIG. 2, for example, in response to receiving a new data item Dₓ with corresponding image Ix and textual description Tₓ, the MLLM in the present system can generate a categorical representation Cₓ for this specific data item. From the generated categorical representation, the present system can extract desired attributes. In some embodiments, the categorical representation Cₓ is computed in a way that maximizes the similarity value within the triplet (Ix, Tₓ, Cₓ). In some embodiments, for the purpose of computing efficiency, the present system may also perform this inference process in a batch mode, allowing multiple data items to be processed simultaneously. This batch-processing capability optimizes resource utilization and accelerates attribute enrichment across large datasets.

### Item Level Processing

FIG. 3 illustrates an exemplary diagram 300 of item-level processing, according to some embodiments. For each data item (e.g., network event, product), values of certain attributes are collected, such as image(s) 302, available textual/numeric attributes 304, and other desired sets of attributes 306. The values of these attributes may be incomplete or inaccurate. The present system employs one or more MLLMs 308 to receive and learn from these incomplete values and predict the missing values to create a complete set of populated product attributes 310. In some embodiments, an MLLM is trained using contrastive learning. In some embodiments, the training is conducted in a batch mode.

### Model Updates

In the present system, the model operates in a “continuous fine-tuning mode.” The model is configured to continuously learn in a supervised manner as new data sources become available or existing datasets expand. This dynamic learning process ensures that the model adapts to evolving patterns and variations in the data. For example, as new network traffic logs are ingested from various sources (e.g., firewalls, IDSs, cloud-based security platforms), the model continuously updates its understanding of normal and anomalous traffic patterns. Alternatively, the model keeps updating from new product feeds when the product catalog continues expanding and/or when new product feed sources (e.g., retailers) are added.

In some embodiments, the present system may use a self-supervised approach to train the model, that is, by feeding the model with a subset of results and predictions from previously inferred examples to fine-tune and improve the performance of the model. For example, in an anomaly detection system, the model may analyze historical traffic data and generate predictions about potential cyber threats. These predictions are then used as training examples to further refine the model's ability to distinguish between benign and malicious traffic. For example, if the present system initially classifies an unusual SSH connection as suspicious but later confirms it as a false positive, the updated classification is fed back into the model to enhance its accuracy in future detections.

### Filtration Mechanism

To maintain the integrity and reliability of the model's learning process, the present system incorporates a filtration mechanism to exclude misleading examples. This ensures that only high-confidence predictions contribute to the model's continuous training. The present system may employ a non-comprehensive combination of confidence-based filtering, comparative verification, and cross-checking with a specialized model described herein to perform the filtration mechanism.

In some embodiments, the model's confidence about its prediction output can be used in the model filtration. This may include a confidence elicitation process without model fine-tuning or access to proprietary information to ensure reliable and trustworthy model predictions. The present system evaluates whether a prediction meets a confidence threshold before accepting it for further processing. For example, an IDS system classifies a network session as a potential attack with a confidence score of 60%, which is below a predefined threshold (e.g., 80%). Using confidence-based filtering, the MLLM may flag this prediction as uncertain, preventing it from influencing the model's future training. Conversely, if the model is highly confident (e.g., 95%) in detecting a known malware signature, this prediction is more likely to be used in self-supervised fine-tuning.

In some embodiments, the present system may use comparative verification in the filtration mechanism, where a couple of example data (e.g., two examples) are presented to the model to verify if the model is internally consistent. For instance, when there are two examples, the present system may include one example data for which the ground truth attribute is known, and another example data for which the attribute is not known and that the model had predicted to be a different value. Using comparative verification, the present system then constructs a prompt to confirm whether the model is consistent with itself. For example, in a network packet classification context, the model (e.g., MLLM) described herein may be provided with a known benign packet labeled from previous datasets and a new packet classified as malicious by the model. If the model identifies inconsistencies, such as classifying the new packet as malicious while failing to justify why this packet differs significantly from the known packet, this may trigger a re-evaluation before incorporating the prediction into the training process of the model. In another example, the MLLM may be provided with a first image of a short-sleeve T-shirt (e.g., ground truth attribute) and a second image of a long-sleeve T-shirt (e.g., previously predicted by the MLLM). Based on these inputs, the present model may be requested to determine which of the two T-shirts has a shorter sleeve, thereby validating if the answer is consistent with its previous prediction on the second image.

In some embodiments, the present system may verify predictions by cross-checking prediction results from the model with a specialized model trained for a specific attribute. This method enhances reliability by ensuring that a general-purpose model aligns with more expert-driven models. For example, a domain name system (DNS) request may initially be classified as suspicious by the MLLM based on the detection of command-and-control (C2) traffic used by malware. The present system can cross-check this classification with a specialized deep-learning model trained exclusively on DNS anomalies. If the specialized model disagrees, the present system flags the prediction as unreliable and excludes it from training the MLLM.

In some embodiments, the present system may also validate if the model predicts the same categorical label for an attribute when it is presented with different subsets of the available information. For example, the present system may compare the prediction made based only on a product image and the prediction made based on the product image and text to evaluate the performance of the model. In some embodiments, the present system may further invoke a powerful ensemble model suite for a subset of examples. Multiple AI models vote on a subset of predictions. If a majority of models agree, the prediction is reinforced; otherwise, the prediction is discarded or flagged for human review.

By implementing the filtration using one or more methods as discussed above, the present system can use highly-confident responses/answers to re-train the model, leading to continuously improved predictions. This prevents the quality of model output from degrading over time, which may result from the self-supervised fine-tuning.

### Agents

An AI agent is a system with complex reasoning capabilities, memory, and means to execute tasks. Specifically, an LLM-powered agent as described in the present system may interact with the MLLM and facilitate data transfer between the model and a data feed database.

The present system may include multiple agents that are configured to execute various tasks, each specialized for a particular task to ensure efficient data enrichment and AI/ML model (e.g., MLLM) training. In some embodiments, the present system may include a data identification agent that scans a data feed database to identify missing, incomplete, or inconsistent information that requires enrichment. This agent ensures that only relevant data entries are sent for further processing, optimizing resource utilization. In some embodiments, the present system may include an attribute selection agent that can identify which attributes of a data item should be used as inputs for the image, text, and/or category encoders in the model. This agent ensures that the correct information is selected to generate accurate embeddings.

In some embodiments, the present system may include a pre-processing agent that prepares inputs to the model by pre-processing the identified items and structuring the data into a suitable format, and, if needed, generating prompts to provide the model with additional context. For example, an agent can be used to normalize raw network data and structure the normalized data into an optimized format before feeding it into an ML-powered anomaly detection system. In some embodiments, the present system may also include a post-processing agent that can process the results from the model and write the processed results to a database if applicable, ensuring seamless data integration. For example, based on the model's output, this agent can automate actions such as flagging or blocking potentially malicious activity.

In addition to handling data, AI agents may also manage the continuous learning process of the AI/ML model. In some embodiments, when new data becomes available in a data feed database, a fine-tuning agent can orchestrate the fine-tuning of the model in a supervised manner, ensuring that the model adapts to the latest product information and maintains high accuracy. In some embodiments, the present system may further include a self-supervised learning agent that may orchestrate the self-supervised learning of the model by evaluating the model's previous predictions and enhancing its accuracy through reinforcement and feedback loops. This agent ensures that the model can continuously improve without human intervention. For example, agents can be used to continuously fine-tune the model by analyzing past false positives/negatives and adjusting detection thresholds accordingly.

### Flowchart

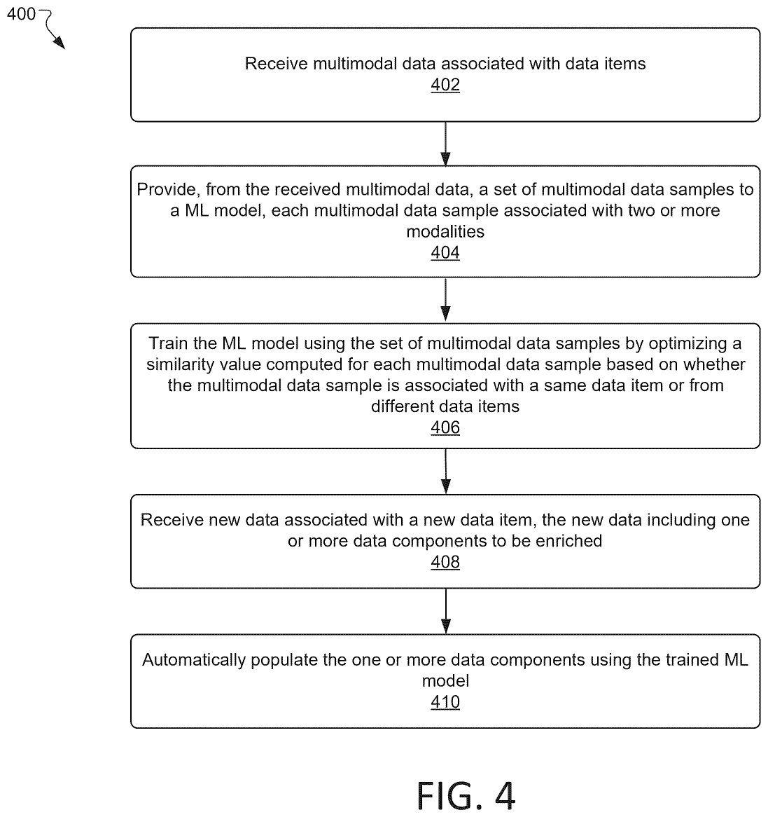

FIG. 4 illustrates an exemplary flowchart of enhancing data feed using an ML model, according to some embodiments. At step 402, the present system receives multimodal data associated with data items. A data item can be network events, system logs, cybersecurity alerts, products, etc. The multimodal data includes information (e.g., attributes, features) of a data item associated with multiple modalities. A modality can include textual content, numeric content, binary content, or multi-media content.

At step 404, the present system provides, from the received multimodal data, a set of multimodal data samples to the ML model, each multimodal data sample associated with two or more modalities. In a network intrusion detection and prevention system, the received data may include network packet data such as IP, port number, protocol, and payload information. The present system may classify the received data into different modalities such as images, text, and categories. Each category may include some attributes. At least a set of the received data classified into different modalities can be used to train the ML model. In some embodiments, the ML model is a multimodal large language model.

At step 406, the present system trains the ML model using the set of multimodal data samples by optimizing a similarity value computed for each multimodal data sample based on whether the multimodal data sample is associated with the same data item or from different data items. In some embodiments, the present system may convert each multimodal data sample of two or more modalities to respective two or more latent representations in an embedding space and compute the similarity value based on the latent representations for each multimodal data sample. The similarity value may be optimized by maximizing the similarity value between matching samples and minimizing the similarity value between non-matching samples.

In some embodiments, each multimodal data sample is a triplet of three modalities, and the ML is trained based on processing a batch of triplets. The ML model can be trained using the set of multimodal data samples by constructing a three-dimensional matrix with each entry being a triplet and each axis of the matrix representing one of the three modalities. The similarity values for diagonal entries of the matrix can be maximized, where the diagonal entries represent the latent representations from the same data item. The similarity values for non-diagonal entries of the matrix can be minimized, where the non-diagonal entries represent the latent representations from different data items. In some embodiments, the similarity value is computed based on determining a vector dot product or cosine similarity.

In some embodiments, the ML model is continuously trained. For example, one or more of confidence-based filtering, comparative verification, and cross-checking with a specialized model may be applied as a filtration mechanism to exclude misleading prediction results from the ML model. When prediction results of the ML are looped back to the ML model to continuously train and refine the ML prediction, no misleading prediction results will be used.

At step 408, the present system may receive new data associated with a new data item. The new data includes one or more data components to be enriched such as missing, incomplete, or inconsistent data. For example, the new data may be from a raw data feed database, and the present system applies the trained ML model to identify the information to be enriched in the raw database and convert this database into an enriched database.

At step 410, the present system can automatically populate the one or more data components using the trained ML model. For example, if the received network packet data is absent of some key attributes such as detailed threat classification, reputation scores, etc., the trained ML model can be applied to infer and/or predict the required data.

### Computer Implementation

In some examples, some or all of the processing described above can be carried out on a personal computing device, on one or more centralized computing devices, or via cloud-based processing by one or more servers. Some types of processing can occur on one device and other types of processing can occur on another device. Some or all of the data described above can be stored on a personal computing device, in data storage hosted on one or more centralized computing devices, and/or via cloud-based storage. Some data can be stored in one location and other data can be stored in another location. In some examples, quantum computing can be used, and/or functional programming languages can be used. Electrical memory, such as flash-based memory, can be used.

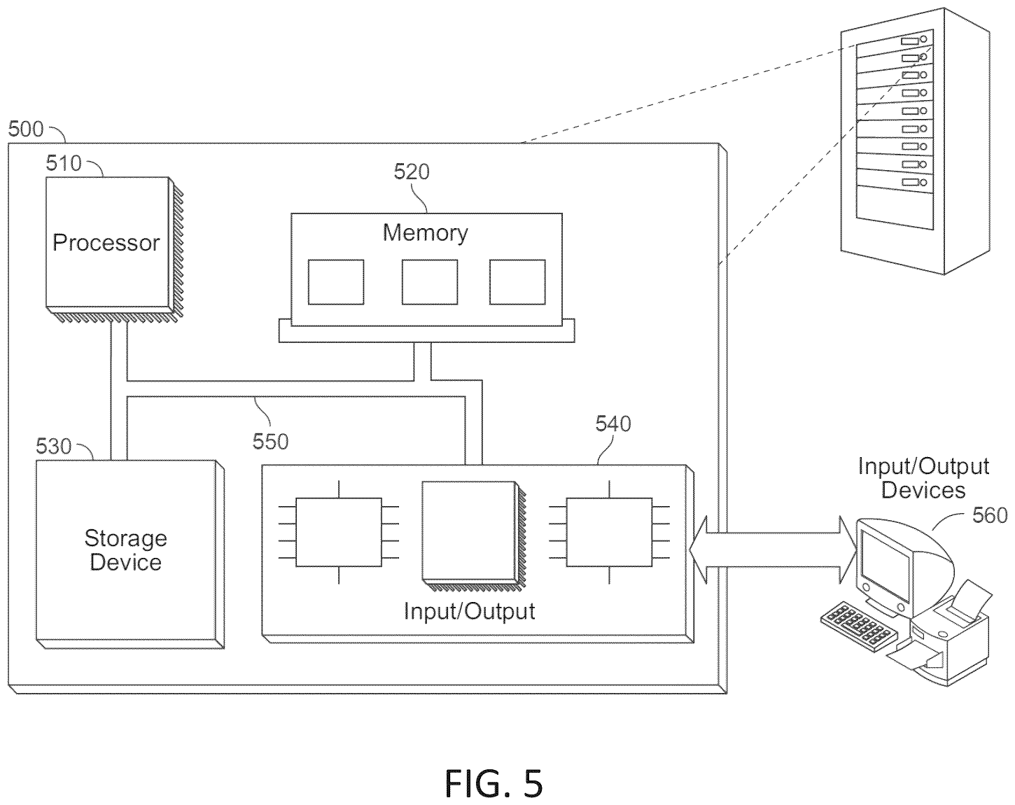

FIG. 5 is a block diagram of an example computer system 500 that may be used in implementing the technology described herein. General-purpose computers, network appliances, mobile devices, or other electronic systems may also include at least portions of the system 500. The system 500 includes a processor 510, a memory 520, a storage device 530, and an input/output device 540. Each of the components 510, 520, 530, and 540 may be interconnected, for example, using a system bus 550. The processor 510 is capable of processing instructions for execution within the system 500. In some implementations, the processor 510 is single-threaded. In some implementations, the processor 510 is a multi-threaded processor. The processor 510 is capable of processing instructions stored in the memory 520 or on the storage device 530.

Memory 520 stores information within the system 500. In some implementations, the memory 520 is a non-transitory computer-readable medium. In some implementations, the memory 520 is a volatile memory unit. In some implementations, the memory 520 is a non-volatile memory unit.

The storage device 530 is capable of providing mass storage for the system 500. In some implementations, the storage device 530 is a non-transitory computer-readable medium. In various implementations, the storage device 530 may include, for example, a hard disk device, an optical disk device, a solid-state drive, a flash drive, or some other large-capacity storage device. For example, the storage device may store long-term data (e.g., database data, file system data, etc.). The input/output device 540 provides input/output operations for the system 500. In some implementations, the input/output device 540 may include one or more network interface devices, e.g., an Ethernet card, a serial communication device, e.g., an RS-232 port, and/or a wireless interface device, e.g., an 802.11 card, a 3G wireless modem, or a 4G wireless modem. In some implementations, the input/output device may include driver devices configured to receive input data and send output data to other input/output devices, e.g., keyboard, printer, and display devices 560. In some examples, mobile computing devices, mobile communication devices, and other devices may be used.

In some implementations, at least a portion of the approaches described above may be realized by instructions that upon execution cause one or more processing devices to carry out the processes and functions described above. Such instructions may include, for example, interpreted instructions such as script instructions, executable code, or other instructions stored in a non-transitory computer-readable medium. The storage device 530 may be implemented in a distributed way over a network, such as a server farm or a set of widely distributed servers, or may be implemented in a single computing device.

Although an example processing system has been described in FIG. 5, embodiments of the subject matter, functional operations, and processes described in this specification can be implemented in other types of digital electronic circuitry, in tangibly embodied computer software or firmware, in computer hardware, including the structures disclosed in this specification and their structural equivalents, or combinations of one or more of them. Embodiments of the subject matter described in this specification can be implemented as one or more computer programs, i.e., one or more modules of computer program instructions encoded on a tangible nonvolatile program carrier for execution by, or to control the operation of, data processing apparatus. Alternatively or in addition, the program instructions can be encoded on an artificially generated propagated signal, e.g., a machine-generated electrical, optical, or electromagnetic signal that is generated to encode information for transmission to a suitable receiver apparatus for execution by a data processing apparatus. The computer storage medium can be a machine-readable storage device, a machine-readable storage substrate, a random or serial access memory device, or a combination of one or more of them.

The term “system” may encompass all kinds of apparatus, devices, and machines for processing data, including by way of example a programmable processor, a computer, or multiple processors or computers. A processing system may include special-purpose logic circuitry, e.g., an FPGA (field programmable gate array) or an ASIC (application-specific integrated circuit). A processing system may include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a standalone program or as a module, component, subroutine, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Computers suitable for the execution of a computer program can include, by way of example, general or special purpose microprocessors or both, or any other kind of central processing unit. Generally, a central processing unit will receive instructions and data from a read-only memory, a random access memory, or both. A computer generally includes a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few.

Computer-readable media suitable for storing computer program instructions and data include all forms of non-volatile memory, media, and memory devices, including way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special-purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's user device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship between client and server arises by virtue of computer programs running on the respective computers and having a client-server relationship with each other.

While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous. Other steps or stages may be provided, or steps or stages may be eliminated, from the described processes. Accordingly, other implementations are within the scope of the following claims.

### Terminology

The phraseology and terminology used herein are for the purpose of description and should not be regarded as limiting.

The indefinite articles “a” and “an,” as used in the specification and in the claims, unless clearly indicated to the contrary, should be understood to mean “at least one.” The phrase “and/or,” as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of or “exactly one of,” or, when used in the claims, “consisting of,” will refer to the inclusion of exactly one element of a number or list of elements. In general, the term “or” as used shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The use of “including,” “comprising,” “having,” “containing,” “involving,” and variations thereof, is meant to encompass the items listed thereafter and additional items.

Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

Each numerical value presented herein, for example, in a table, a chart, or a graph, is contemplated to represent a minimum value or a maximum value in a range for a corresponding parameter. Accordingly, when added to the claims, the numerical value provides express support for claiming the range, which may lie above or below the numerical value, in accordance with the teachings herein. Absent inclusion in the claims, each numerical value presented herein is not to be considered limiting in any regard.

The terms and expressions employed herein are used as terms and expressions of description and not of limitation, and there is no intention, in the use of such terms and expressions, of excluding any equivalents of the features shown and described or portions thereof. In addition, having described certain embodiments of the invention, it will be apparent to those of ordinary skill in the art that other embodiments incorporating the concepts disclosed herein may be used without departing from the spirit and scope of the invention. The features and functions of the various embodiments may be arranged in various combinations and permutations, and all are considered to be within the scope of the disclosed invention. Accordingly, the described embodiments are to be considered in all respects as only illustrative and not restrictive. Furthermore, the configurations, materials, and dimensions described herein are intended as illustrative and in no way limiting. Similarly, although physical explanations have been provided for explanatory purposes, there is no intent to be bound by any particular theory or mechanism, or to limit the claims in accordance therewith.

What is claimed is:

1. A computer-implemented method of enhancing data feed using a machine learning model, the method comprising:
receiving multimodal data associated with a plurality of data items;
providing, from the received multimodal data, a set of multimodal data samples to a machine learning (ML) model, each multimodal data sample associated with two or more modalities;
training the ML model using the set of multimodal data samples by optimizing a similarity value computed for each multimodal data sample based on whether the multimodal data sample is associated with a same data item or from different data items;
receiving new data associated with a new data item, the new data including one or more data components to be enriched; and
automatically populating the one or more data components using the trained ML model.

2. The method of claim 1, further comprising:
converting each multimodal data sample of two or more modalities to respective two or more latent representations in an embedding space; and
computing the similarity value based on the latent representations for each multimodal data sample,
wherein optimizing the similarity value comprises maximizing the similarity value between matching samples and minimizing the similarity value between non-matching samples.

3. The method of claim 2, wherein a modality comprises textual content, numeric content, binary content, or multi-media content.

4. The method of claim 3, wherein each multimodal data sample is a triplet of three modalities, and the ML is trained based on processing a batch of triplets.

5. The method of claim 4, wherein training the ML model using the set of multimodal data samples comprises:
constructing a three-dimensional matrix with each entry being a triplet and each axis of the matrix representing one of the three modalities;
maximizing similarity values for diagonal entries of the matrix, the diagonal entries representing the latent representations from the same data item; and
minimizing similarity values for non-diagonal entries of the matrix, the non-diagonal entries representing the latent representations from different data items.

6. The method of claim 4, wherein the triplet comprises an image, a text description, and a category associated with a data item, the method further comprises:
training the ML model to predict category-specific attributes based on classification of the data item,
wherein automatically populating the one or more data components comprises generating the category-specific attributes.

7. The method of claim 1, further comprising:
using retrieval-augmented generation (RAG) to automatically generate contextual prompts; and
providing categorical labels and prompts as context to the ML model to refine prediction of the ML model.

8. The method of claim 1, further comprising continuously refining prediction of the ML model by employing at least one of (1) supervised learning on the new data, and (2) self-supervised learning on previously generated labels and predictions.

9. The method of claim 8, further comprising:
using one or more of confidence-based filtering, comparative verification, and cross-checking with specialized model as a filtration mechanism to exclude misleading prediction results from the ML model; and
providing prediction results without the misleading prediction results to continuously train the ML model.

10. The method of claim 1, wherein the ML model is trained on the set of multimodal data samples in a batch mode.

11. The method of claim 1, wherein the attributes to be enriched comprises missing, incomplete, or inconsistent data.

12. The method of claim 1, further comprising computing the similarity value based on determining a vector dot product or cosine similarity.

13. The method of claim 1, wherein the ML model comprises a multimodal large language model (MLLM).

14. A computing system for enhancing data feed using a machine learning model, the computing system comprising:
a processor; and
a memory in communication with the processor and comprising instructions which, when executed by the processor, program the processor to:
receive multimodal data associated with a plurality of data items;
provide, from the received multimodal data, a set of multimodal data samples to a machine learning (ML) model, each multimodal data sample associated with two or more modalities;
train the ML model using the set of multimodal data samples by optimizing a similarity value computed for each multimodal data sample based on whether the multimodal data sample is associated with a same data item or from different data items;
receive new data associated with a new data item, the new data including one or more data components to be enriched; and
automatically populate the one or more data components using the trained ML model.

15. The system of claim 14, wherein the instructions further program the processor to: convert each multimodal data sample of two or more modalities to respective two or more latent representations in an embedding space; and
compute the similarity value based on the latent representations for each multimodal data sample,
wherein optimizing the similarity value comprises maximizing the similarity value between matching samples and minimizing the similarity value between non-matching samples.

16. The system of claim 15, wherein a modality comprises textual content, numeric content, binary content, or multi-media content.

17. The system of claim 16, wherein each multimodal data sample is a triplet of three modalities, and the ML is trained based on processing a batch of triplets.

18. The system of claim 17, wherein, to train the ML model using the set of multimodal data samples, the instructions further program the processor to:
construct a three-dimensional matrix with each entry being a triplet and each axis of the matrix representing one of the three modalities;
maximize similarity values for diagonal entries of the matrix, the diagonal entries representing the latent representations from the same data item; and
minimize similarity values for non-diagonal entries of the matrix, the non-diagonal entries representing the latent representations from different data items.

19. The system of claim 17, wherein the triplet comprises an image, a text description, and a category associated with a data item, and the instructions further program the processor to:
train the ML model to predict category-specific attributes based on classification of the data item,
wherein automatically populating the one or more data components comprises generating the category-specific attributes.

20. A computer program product for enhancing data feed using a machine learning model, the computer program product comprising a non-transitory computerreadable medium having computer readable program code stored thereon, the computer readable program code configured to:
receive multimodal data associated with a plurality of data items;
provide, from the received multimodal data, a set of multimodal data samples to a machine learning (ML) model, each multimodal data sample associated with two or more modalities;
train the ML model using the set of multimodal data samples by optimizing a similarity value computed for each multimodal data sample based on whether the multimodal data sample is associated with a same data item or from different data items;
receive new data associated with a new data item, the new data including one or more data components to be enriched; and
automatically populate the one or more data components using the trained ML model.
